(19) United States
(12) Patent Application Publication
(10) Pub. No.: US 2009/0104311 A1
(43) Pub. Date: Apr. 23, 2009

(54) Active Ingredient Depot

(76) Inventor: Boris Ouriev, Niederuzwil (CH)

Correspondence Address: Francis C. Hand;Carella, Byrne, Bain, Gilfillan, Cecchi, Stewart &, Olstein, 5 Becker Farm, Roseland, NJ, 07068, US

(21) Appl. No.: 11/921,052

(22) PCT Filed: May 27, 2005
(86) PCT No.: PCT/CH2005/000303

§ 371 Date: Dec. 26, 2007

(51) Int. Cl. A23L 1/48

(52) U.S. Cl. 426/68; 426/89; 426/100

(57) ABSTRACT

The active ingredient depot, in one embodiment, is a closed double-walled tube having at least one pressure-sensitive outlet at one end in the form of one of a membrane, a diaphragm and a valve; and an active substance embedded therein. In another embodiment, the active ingredient depot, is an encapsulation, such as an ice cube, having a outer surrounding wall and an inner dissolvable wall defining a cavity in which an active substance is disposed.

The invention relates to an active substance depot, in particular for consuming said substances, wherein the substances as such exist as a liquid and/or solid in a bound state.

It is well-known to store and preserve natural flavors in juices or fruit for an extended period of time and to take out portions of them to be consumed.

EP-A-847700 discloses a method of concentrating flavors, wherein concentrated flavors such as tea or fruit flavors are provided in solid form and are soluble in water. This enriched solution is cooled to become ice, in order to separate weakly flavored components.

From WO 02/100740 it is known to provide a drinkable liquid in the form of ice portions comprising at least 95% water and salt. For instance, the ice portions are used for cooling and flavor enrichment of drinks.

It is an object of the invention to provide an active substance/ingredient depot, wherein the active substances and/or flavors exist in portions and in a shelf-stable manner and may be liberated for consumption. This object is achieved by the features of the claim. Preferred embodiments are disclosed in the sub-claims.

The invention starts out from the idea of providing active substances and/or flavors in a shelf-stable manner and in portions for consumption without having to take up each of these portions from a separate storage container or the like and/or having to bring along such container.

Active substances or active ingredients as construed by the present invention also include food additives, fruit juices, fruit or fruit pieces, vitamins, minerals, color, taste, flavors, etc. Medicinal substances may be included as well.

The active substances are enclosed in an encapsulation and are released when this encapsulation is opened or dissolved.

This can be done by using at least double-walled drinking tubes or by embedding within ice cubes. When using embedding within ice cubes or the like, the flavors may also be stored in different layers or in and/or with fruit.

The invention will now be described in more detail with reference to four embodiments in a drawing, wherein:

FIG. 1 shows a double-walled drinking tube (“straw”) in a cross-section;

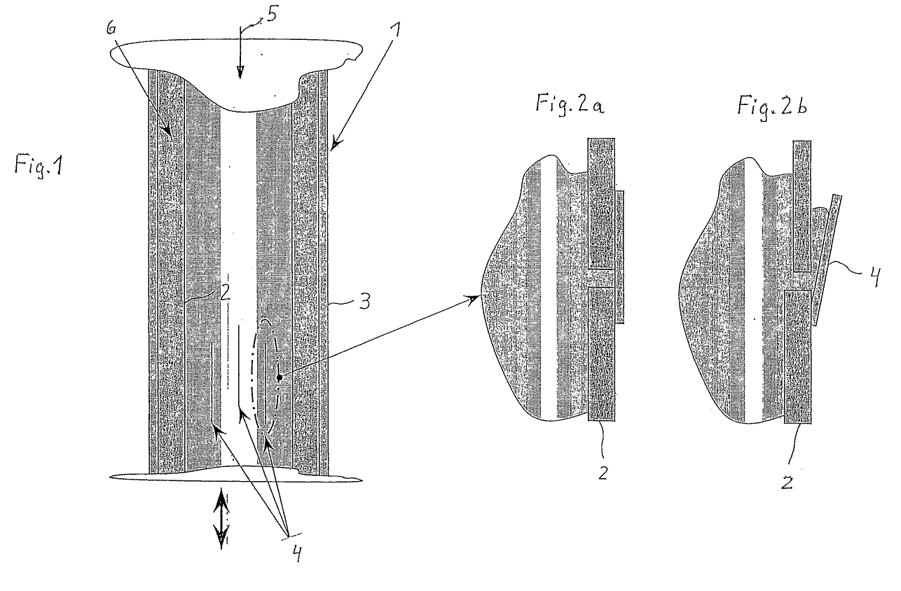

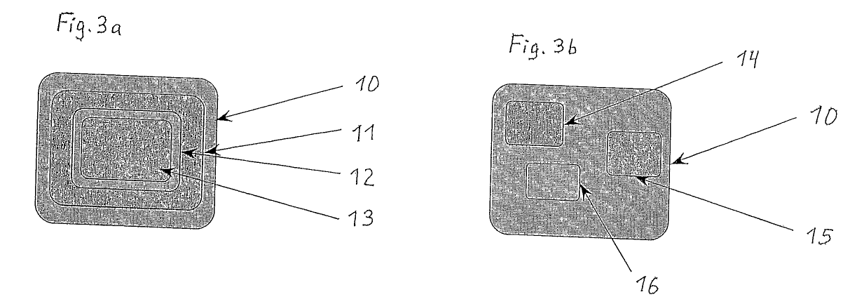

FIG. 2 shows a valve arrangement at the drinking tube
a, with the valve closed
b, with the valve opened;

FIG. 3 shows ice cubes
a, with flavors arranged in a layered structure
b, with flavors arranged in a discrete manner;

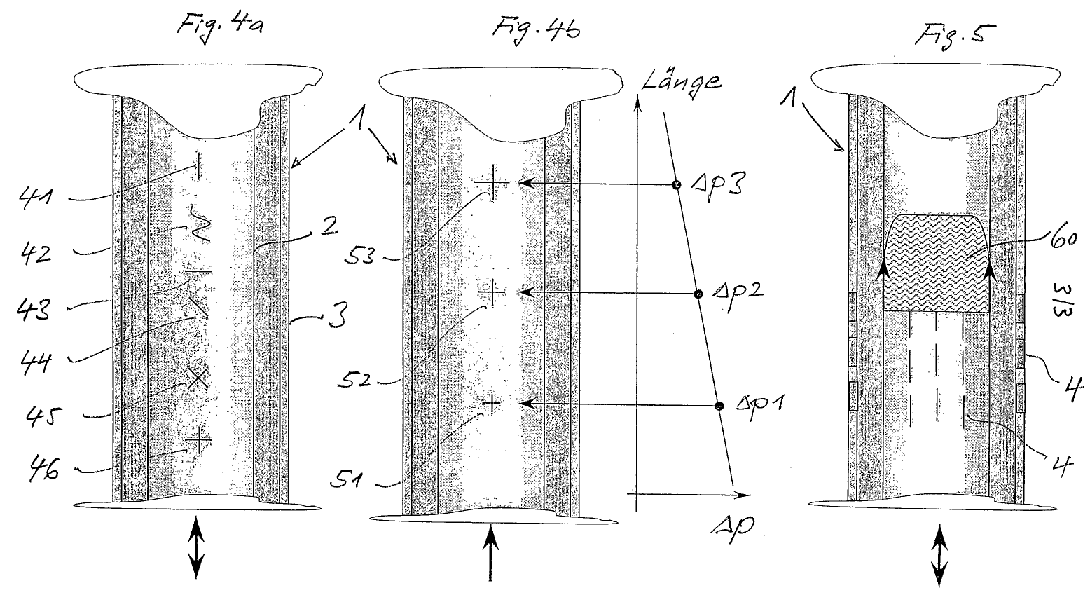

FIG. 4 shows further valve arrangements at the drinking straw
a, with slit-type valves having different shapes and orientation
b, with valves adapted to the pressure conditions within the tube;

FIG. 5 shows a “drinking aid” for high-viscosity foods.

FIG. 1 shows a drinking tube 1 which consists of a polymer material and is manufactured in a double-walled manner by extrusion. At one end, the inner tube 2 or the outer tube 3 comprises a valve 4 (or a membrane, diaphragm etc.) which reacts to pressure (as can be seen in FIGS. 2a and 2b). In general, the drinking tubes may consist of organic or inorganic materials which are nutritionally safe and acceptable for food applications.

The hollow space is filled with liquid active substances or flavors, such as a fruit juice concentrate 6, and the active substances or flavors are released by pressure 5 at the other end spaced from valve 4 of drinking tube 1. For instance, in a drinking vessel filled with water. When pressure 5 is stopped or withdrawn, valve 4 closes again, and the active sub-stances or flavors may be released according to individual needs.

In a drinking tube 1 having at least three walls, different active substances or flavors etc. can be mixed.

Alternatively, the inner tube 2 may be replaced by a wall or layer easily dissolvable, for instance in water. If this wall or layer itself is able to receive the active substances or flavors, it may be arranged directly on the inside of the outer tube.

FIGS. 3a and 3b show an ice cube 10 consisting of individual layers 11, 12, 13 and containing different active substances or flavors. Or these active substances or flavors are stored in a spatially concentrated manner. Embedding or encapsulation by water ice is possible. The individual layers or components may differ in color, smell or taste, and the inner components or layers may melt simultaneously or (temporally) delayed with respect to outer layers. Also, the layers may contain non-frozen substances (e.g. alcohols) which are suitably encapsulated (e.g. with chocolate). Similarly, the active substances or flavors may be concentrated in a discrete manner, for instance encapsulated as flavors 14 or pieces of fruit 15, 16.

Instead of water, any other water-containing substances may be used individually or consisting of several components.

FIG. 4a shows valve arrangements 41, 42, 43, 44, 45, 46 at the drinking tube 1. Each of the illustrated valve arrangements is formed as a cut in the inner tube 2 and/or the outer tube 3 of drinking tube 1. Depending on length, orientation and shape of each individual cut 41, 42, 43, 44, 45, 46 in each of the tubes, a different resistance of the valve formed in such a way is achieved. For instance, valve 41 oriented in parallel to the longitudinal direction of drinking tube 1 has a smaller fluid resistance than valve 43 oriented orthogonally to the longitudinal direction of drinking tube 1, while the fluid resistance of valve 44 oriented at an angle with respect to the longitudinal direction of drinking tube 1 has a value in between the value for valve 41 and the value for valve 43. By combining these valve basic elements 41, 43, 44, optimal valves 42, 45, 46 for the rheological properties of each of the fluids involved can be provided.

The manufacture of these specifically designed cut-type valves or slit-type valves 41, 42, 43, 44, 45, 46 in an elastic tube wall may, for instance, be carried out by cutting, in particular laser cutting, of the drinking tubes 1 in the above-mentioned extrusion process.

FIG. 4b shows a drinking tube 1 where valves 51, 52, 53 are adapted to the pressure conditions in the drinking tube 1. Given that, when drinking, a pressure difference Δp decreasing from the lower tube end (end in the drinking vessel filled with liquid) to the upper tube end (in the mouth) is established between the outside and the inside of drinking tube 1, valves 51, 52, 53 may be designed as illustrated in order to produce a fluid resistance which decreases from the bottom to the top as well. As a result, the amount of fluid sucked from the outside into the inside of drinking tube 1 is substantially constant along its length.

FIG. 5 shows a drinking tube 1 which may be used as a “drinking aid” for high viscosity food items such as pudding, yoghurt, etc. The low viscosity fluid, such as water or juice, penetrating from the outside into tube 1 through valves 4, produces a gliding layer between the high-viscosity food item, shown as a plug 60, and the inner wall of tube 1, reducing the gliding resistance (slippage resistance) at the inner wall. As a result, sucking up the high-viscosity food item through drinking tube 1 is facilitated.

1.-8. (canceled)

9. An active substance depot comprising
a closed at least double-walled tube having at least one pressure-sensitive outlet at one end thereof, said outlet being in the form of one of a membrane, a diaphragm and a valve; and
an active substance embedded in said double-walled tube.

10. An active substance depot as set forth in claim 9 wherein said active substance is temporarily embedded in said double-walled tube.

11. An active substance depot as set forth in claim 10 wherein said active substance is frozen.

12. An active substance depot as set forth in claim 10 wherein said active substance is embedded in water ice.

13. An active substance depot as set forth in claim 9 wherein said pressure-sensitive outlet is a valve formed as a cut in at least one tube of said double-walled tube.

14. An active substance depot as set forth in claim 9 wherein said double-walled tube has a plurality of pressure-sensitive outlets at one end thereof, each said outlet being formed as a cut in at least one tube of said double-walled tube.

15. An active substance depot comprising
an encapsulation having a outer surrounding wall and an inner dissolvable wall defining a cavity; and
an active substance disposed within said cavity of said inner wall.

16. An active substance depot as set forth in claim 15 wherein said encapsulation is an ice cube.

17. An active substance depot as set forth in claim 15 wherein said active substance is a liquid.

18. An active substance depot as set forth in claim 15 wherein said active substance is a solid.
